(19) United States
(12) Patent Application Publication
(10) Pub. No.: US 2013/0054357 A1
(43) Pub. Date: Feb. 28, 2013

(54) METHOD AND SYSTEM FOR SHARING INFORMATION

(71) Applicants: David Andrew Mager, Berkeley, CA (US); Jeffrey Richard Hickman, Superior, CO (US); Geoffrey Smalling, San Anselmo, CA (US)

(72) Inventors: David Andrew Mager, Berkeley, CA (US); Jeffrey Richard Hickman, Superior, CO (US); Geoffrey Smalling, San Anselmo, CA (US)

(21) Appl. No.: 13/593,990

(22) Filed: Aug. 24, 2012

Related U.S. Application Data
(60) Provisional application No. 61/527,566, filed on Aug. 25, 2011.

(51) Int. Cl. G06Q 30/02

(52) U.S. Cl. 705/14.49

(57) ABSTRACT

A system and method for sharing information is described. A product identification user interface is displayed to a user. Identifying information is accepted from the user via said product identification user interface. The identifying information is sent to a server configured to identify a product based on said identifying information. A request is accepted comprising a question about the product from the user. The request is sent to a selected group comprising at least one member. At least one response is received from at least one member of the selected group. The at least response is displayed. At least one targeted deal related to said identified product is received from the server. At least one targeted deal related to said identified product is displayed.

The present application claims the benefit of U.S. Provisional Application Ser. No. 61/527,566, filed Aug. 25, 2012, which is herein incorporated by reference for completeness of disclosure.

### BACKGROUND OF THE INVENTION

1. Field of the Invention

The technology described in this patent document relates to computer systems. More specifically, the technology described in this patent document relates to a method and system for sharing information.

2. Description of the Related Art

The use of communication devices like mobile devices, PDA's, etc. to get feedback or refer a product/service has grown in popularity in recent years as these devices allow users to share information through e-mail, instant messaging, social networking, and the like. However, it requires a substantial amount of effort to get feedback or refer or a product to a specific set of friends since sending the right message to the right people with the right tone is time consuming.

As such, more often than not, many products or services are not shared by the user for any reason. There are other reasons as well for not sharing the product or service, particularly to those friends who are connected through social networks like Facebook™, Twitter™, or Linkedln, etc., including for example, privacy concerns, lack of interest of the recipients, limited ability to communicate across social platforms, etc. Further, users are often hesitant to share information with others to avoid experiencing a feeling of lack of control of their information within a system.

For a combination of reasons that vary by person, products and services, more often than not feedback, referrals or referral requests do not happen. For manufacturers, retailers, and local service providers, this means that there is a large word of mouth opportunity that is not flowing like it should be. Today, many shopping/couponing efforts have taken the old concept of “pushing” and extended it to web and mobile applications in the form of advertising and couponing. These advertisers pay large margins to expose their product or service to a large audience using the internet and mobile channels. Good returns have occurred, but the consumers are often “coupon overloaded.”

Social media networks are great for sharing information. Today, there are opt-in solutions that are driven by the merchant or manufacturer. The benefits of these systems are to generate awareness, trial, or increase loyalty. In addition, these systems along with merchants and manufacturers attempt to identify consumer buying profiles to target ads/coupons to those profiles and preferences. In order to achieve these benefits, merchant and manufacturers are willing to provide discounts to customer that take advantage of their offers and provide solutions that are organized in many ways, for example, geographical (Groupon), retailer (Safeway, Target), social media (Buycasts for Facebook™), ratings (Yelp), social buying (Fondalo using Facebook™), web/social data mining (Media6), online paid referral (tipfrom.me), private social network (Path), or shopping (ShopSavvy), niche group buying (esworm), and the like.

However, many existing social networks only allow for “likes”. Facebook™ can't do a “dis-like” because their traffic and business model is built on advertisers. For example, existing social networks can't entice advertisers if people are “dis-liking” a product/brand. Thus, “liking” something isn't genuine feedback in the Facebook™ world.

Furthermore, many of these solutions have added simple messaging options within them, but they are reliant on broadcasting to a social media network or emailing to friends individually. None of the solutions has the ability to create and maintain specific conversations with a selected set of people in a single instance through an appropriate application designed for products. Such a user-friendly system would provide platform to have many conversations around products, thereby capturing and monetizing these interactions among friends or groups of people. A user-friendly product conversation application capable of implementing this platform would enable users to provide and share advice on a product/service, thereby putting consumers back in control. Specifically, users are in control because the interaction medium/location is managed by the user. If a user doesn't want a social network (e.g. Facebook™) to know they are looking at a certain product, they can send the information directly to a friend (not a whole group). Thus, privacy is controlled by the user, and they dictate who sees what. The user decides whether the interactions are person to person, person to group, person to entire social network, or any combination thereof. The product conversation system also facilitates referrals, feedback, and recommendations.

To overcome the problems and limitations described above there is a need for a method and system for sharing information.

### BRIEF SUMMARY OF THE INVENTION

The disclosed embodiments overcome shortcomings of prior product referral and feedback applications by a product conversation application that is able to integrate a communication device, deals and e-commerce and facilitating person-to-person referrals, recommendations or feedback without users having to previously create or pre-join a specific network or group. Specifically, users can use the product conversation application without being required to first create a group or invite other users to join the group in order for the group to exist or the users to interact. The disclosed embodiments may relate to a platform for genuine feedback, positive or negative.

In addition, the disclosed embodiments provide a solution that involves two distinct components: 1) a consumer facing application to enable a conversation between users, and 2) a deal engine that allows marketers/retailers to inject relevant offers to users during that product conversation. Thus, the disclosed embodiments relate to a method and system for sharing information on a product or a service using a communication device having a product conversation application. The product conversation application disclosed herein preferably includes features that provide one or more of a platform to instantly respond to a referral, recommendation request or feedback with a streamlined communication, a personal deal application that embeds targeted deals within quick product conversations, a platform to a marketer/retailer to inject relevant offers to a specific user, incentives to a user who receives a referral on a product/service, for example, if the user buys the product using the product conversation application, information on the available offers, locations to purchase, and reviews/ratings to the users, and the like.

In one or more embodiments, special incentives are be offered to individuals at the same time or shortly after feedback or a referral, and should increase purchases substantially.

One or more embodiments of systems and methods for sharing information described herein are directed to a system including at least one processor and a computer-readable medium including computer readable instructions for sharing information. Execution of the computer readable instructions by the computer performs steps including displaying a product identification user interface to a user, accepting identifying information from the user via the product identification user interface, sending the identifying information to a server configured to identify a product based on the identifying information, accepting a request including a question about the product from the user, sending the request to a selected group including at least one member, receiving at least one response from at least one member of the selected group, displaying the at least response, receiving at least one targeted deal related to the identified product from the server, and displaying the at least one targeted deal related to the identified product.

In one or more embodiments, the product includes a generic product category.

In one or more embodiments, the request is sent to the selected group by sending the request to a server configured to send the request to the selected group.

In one or more embodiments, the product identification user interface is configured to accept identifying information including a captured image.

In one or more embodiments, the captured image is selected from a complete or partial screen shot, an camera capture, a bar code, and a product image.

In one or more embodiments, the product identification user interface is displayed when the user is participating in a shopping experience to obtain real-time feedback from the selected group regarding a potential purchase.

In one or more embodiments, the response is selected from at least one of a binary response indicating positive or negative feedback, a custom message, and a preformed message.

In one or more embodiments, the request is sent via at least one communication channel selected from SMS, MMS, email, a social network, and a proprietary channel.

In one or more embodiments, the steps further include the steps of displaying a communication user interface configured to accept group member data usable to associate a contact with at least one group, at least one communication channel, and optionally at least one communication-channel specific address.

In one or more embodiments, different members of the selected group are associated with different communication channels, where the request is sent to the different members via the different communication channels.

In one or more embodiments, the steps further include receiving an incoming request from a second user including a question about an second product from the second user, and sending an incoming request response to the incoming request, where the incoming request includes at least one of a binary response indicating positive or negative feedback, a custom message, and a preformed message from the user about the second product.

In one or more embodiments, the incoming request is received via at least one communication channel selected from SMS, MMS, email, a social network, and a proprietary channel.

In one or more embodiments, the steps further include receiving at least one targeted deal related to the second product from the server, and displaying the at least one targeted deal related to the second product.

In one or more embodiments, the user is a public figure.

In one or more embodiments, the at least one processor and the computer-readable medium are components of a mobile device.

In one or more embodiments, at least one of the product identification user interface, the at least one response and the at least one targeted deal are displayed in a browser.

One or more embodiments of systems and methods for sharing information described herein are directed to a system including at least one processor and a computer-readable medium including computer readable instructions for sharing information. Execution of the computer readable instructions by the computer performs steps including receiving identifying information about a product from a requesting user, identifying at least one of a product brand and a product category based on the identifying information, accepting a request including a question about the product from the requesting user, accepting a selected group including at least one member from the requesting user, identifying a communication channel and optionally a communication-channel specific address for the at least one member of the selected group, sending the request to the at least one member of the selected group via at least one communication channel to at least one identified communication-channel specific address, determining at least one targeted deal related to the product, and providing the at least one targeted deal to at least one of the user and the at least one group member.

In one or more embodiments, the steps further include receiving at least one response from at least one member of the selected group, aggregating the at least one response, and providing the at least one response to the requesting user.

In one or more embodiments, the steps further include storing usage information including at least one action of at least one user, and analyzing the usage information to determine at least one tracking metric, where the at least one targeted deal is determine based on the at least one tracking metric.

In one or more embodiments, the usage information includes at least one of a geographic location of the product, a geographic location of the requesting user, a geographic location of the at least one member, referrals, local deals in the nearby vicinity, a time of day of request, brand and model information, a product category, trends over time, trends between “local” groups and “social” groups, communication channels, adoption of mobile purchasing by users, phone type, click rates, discount value, and discount type.

### BRIEF DESCRIPTION OF THE DRAWINGS

The above and other aspects, features and advantages of the invention will be more apparent from the following more particular description thereof, presented in conjunction with the following drawings wherein:

FIG. 1 is a diagram showing an exemplary data sharing and feedback system in accordance with one or more methods and systems for sharing information.

FIG. 2 illustrates an exemplary flow for sharing information in accordance with one or more methods and systems for sharing information.

FIG. 3 illustrates an exemplary diagram of referring a product in accordance with one or more methods and systems for sharing information.

FIG. 4 illustrates an exemplary diagram of requesting feedback in accordance with one or more methods and systems for sharing information.

FIG. 5 illustrates an exemplary diagram of a usage scenario in accordance with one or more methods and systems for sharing information.

FIG. 6 illustrates an exemplary diagram of a usage scenario in accordance with one or more methods and systems for sharing information.

FIG. 7 illustrates an exemplary diagram of a usage scenario in accordance with one or more methods and systems for sharing information.

FIG. 8 illustrates an exemplary diagram of a usage scenario in accordance with one or more methods and systems for sharing information.

FIG. 9 illustrates an exemplary diagram of a usage scenario in accordance with one or more methods and systems for sharing information.

FIGS. 10A-C illustrate exemplary user interfaces in accordance with one or more methods and systems for sharing information.

FIG. 11 illustrates an exemplary flow for providing retailer feedback in accordance with one or more methods and systems for sharing information.

FIG. 12 illustrates an exemplary user interface experience for a purchase in accordance with one or more methods and systems for sharing information.

FIG. 13 illustrates an exemplary eCommerce flow in accordance with one or more methods and systems for sharing information.

FIG. 14 illustrates a general-purpose computer and peripherals that when programmed as described herein may operate as a specially programmed computer capable of implementing one or more methods, apparatus and/or systems in accordance with one or more methods and systems for sharing information.

### DETAILED DESCRIPTION

A METHOD AND SYSTEM FOR SHARING INFORMATION will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary kill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, ‘second” and the like, herein do not denote any order, quantity or importance, but rather are used to distinguish one element from another, and the terms “a” and “an” herein do not denote a limitation of quantity, but rather denote the presence of at least one of the referenced item.

As used herein, the term “product” may refer to any product and/or any service, including any combination thereof. The term “product/service” is also used to refer to any product and/or any service, including any combination thereof.

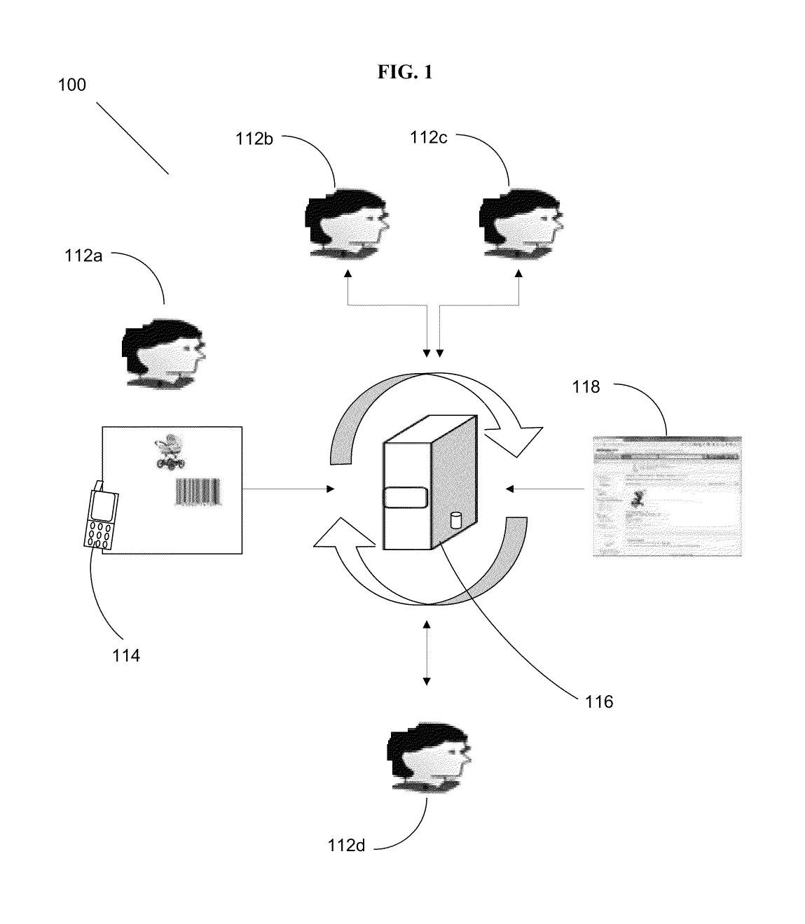

FIG. 1 illustrates an exemplary architecture for the disclosed data sharing and feedback system 100 in which the disclosed embodiment may function. The data sharing and feedback system 100 preferably includes a plurality of users, for example, a first user 112a, a second user 112b, a third user 112c and a fourth user 112d, a communication device 114 with a product conversation application (which may be referred to as the “PodNod application”), a computer system/server 116 (which may be referred to as the “PodNod system”), and, in some cases, a web application 118, which can be a web page or other application that is used to purchase products/services.

As shown in FIG. 1, the first user 112a using the communication device 114 having the product conversation application, can create a new list of contacts or can select an existing list of contacts. The first user 112a can select one or more desired recipients, for example, an individual, a group of individuals, a specific group of friends, etc. to share the product/service. Users can also add contacts from “social networks” such as Facebook™, Twitter™ or the like. The first user 112a using the communication device 114 having the product conversation application can send a product/service information to the plurality of users e.g. second user 112b, third user 112c and fourth user 112d either in combination or on individual basis. The product information to the second user 112b, the third user 112c and the fourth user 112d (herein termed as “recipients”) are notified according to their individual preferences if they are already users/members. Otherwise, recipients can be notified via SMS, email, and the like, depending on how the first user 112a chose to communicate with them. The communication between the recipients and the first user 112a takes place by a connect application in the product conversation system 116. The product conversation system 116 is the central repository for the conversation between the recipients and the first user 112a. Embedded mobile web or Web application 118 can be used by any user to purchase the product/service, for example, online via a web page or other application. According to the disclosed embodiment, any appropriate eCommerce site can be used to purchase and, as needed, collect an affiliate fee.

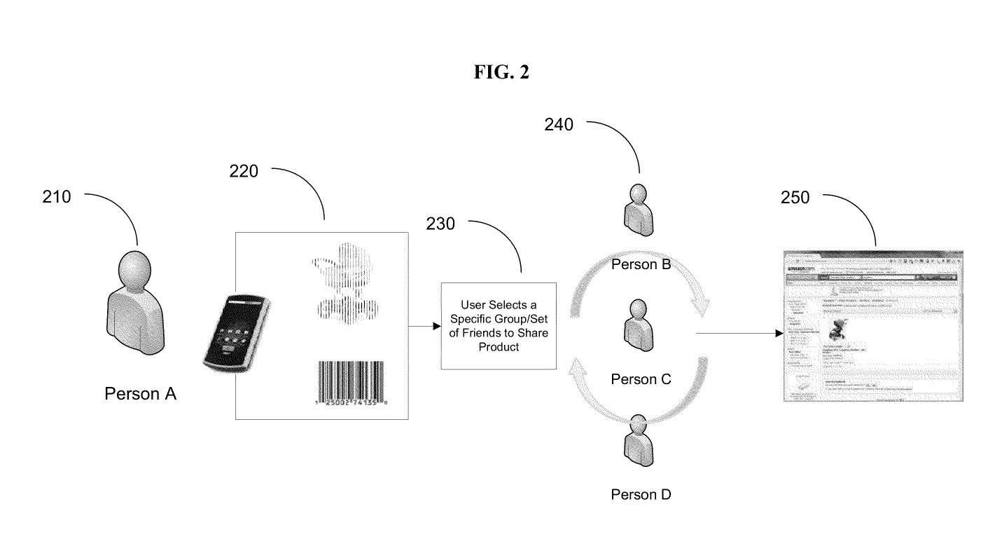

FIG. 2 illustrates an exemplary flow for sharing information according to the disclosed embodiment. In step 220, a user 210 identifies a product or service of interest, preferably using his or her mobile device. Then, in step 230, user 210 selects additional users 240 with which to share the product/service. The additional users can give immediate feedback using the product conversation application. User 210 can act based on the feedback from the additional users, for example, by purchasing the product/service in step 250.

Communication Device

The systems and methods described herein are designed to be used on anymobile/computing device capable of running the application and having appropriate levels of connectivity. This includes, for example, mobile phones, Smartphone, tablets, PDA's, laptop computers, desktop computers, and any other suitable communications device.

Generally speaking, suitable computing devices will be computing devices that include one or more processing devices designed to process instructions, for example computer readable instructions (e.g., code) stored on a storage device. By processing instructions, the processing devices may perform the steps and functions disclosed herein with reference to the applications. The storage device may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. The computing devices additionally may have a memory, an input controller, and an output controller. A bus may operatively couple components of the computing devices, including processors, memories, storage devices, input controllers, output controllers, and any other devices (e.g., network controllers, sound controllers, etc.). An output controller may be operatively coupled (e.g., via a wired or wireless connection) to a display device (e.g., a monitor, television, mobile device screen, touch-display, etc.) in such a fashion that the output controller can transform the display on the display device (e.g., in response to modules executed). An input controller may be operatively coupled (e.g., via a wired or wireless connection) to an input device (e.g., mouse, keyboard, touch-pad, scroll-ball, touch-display, etc.) in such a fashion that input can be received from a user.

Of course, each computing device described herein may have its components be either separate devices (e.g., a personal computer connected by wires to a monitor and mo use), or integrated into a single device (e.g., a mobile device with a touch-display, such as aSmartphone or a tablet), or any combination of devices (e.g., a computing device operatively coupled to a touch-screen display device, a plurality of computing devices attached to a single display device and input device, etc.).

Mobile Network

The disclosed embodiments may be implemented using any type of network allowing communication between mobile/computing devices and the related servers. The servers may be one or more servers, for example a farm of networked servers, a clustered server environment, a cloud network of computing devices, and the like Suitable networks include, for example, any network offered by mobile communications providers (e.g. Verizon, AT&T, etc.), WiFi networks, local or regional networks, and the like. The disclosed embodiments are described with reference to the use of a mobile network having Internet connectivity. Such a network provides optimal connectivity and ease of use for all users.

User Interface

The disclosed embodiments can be implemented and presented to a user using any suitable user interface. As disclosed herein, the user interface is preferably presented to a user on his or her mobile device, which is capable of presenting data to the user and receiving inputs from the user.

Offline/Online Syncing

While the disclosed embodiment generally assumes that each user will be online via his or her mobile device, the embodiments described herein are equally applicable to user's having only periodic connectivity.

Overview of the System

The disclosed embodiment provides a system and method for allowing users to exchange information about a product or service quickly. The disclosed embodiment allows users to receive information by first identifying a product (e.g. capturing an image of the product, ask about a specific product using search or bar code scan, etc.), ask a custom question about the product or utilize pre-set messages, send the request to just the right friends (e.g., select a pod of friends you've sent request to before or even a few pods, send a request via a social network, etc.), receive responses (e.g. a tally of Nod's and Nah's along with friends comments, ask friends to give more info if you need it, etc.), tell the other users or the community what happened (e.g. your friends helped you, now tell them what you decided to do, let others know you no longer need their advice, etc.), add items of interest that you've identified to a personal wish list that can also be shared with friends, recommend products that you love to friends that you think would also enjoy it, send multiple products to friends asking for their ideal pick, or interact with friends to borrow items they may have that you need to use.

Thus, the system of the disclosed embodiments provides a method and system for users to share and refer relevant information by taking advantage of the product conversation application for sharing product/service information within a specific set of friends/contacts. The product conversation application is a person-to-person product conversation application that integrates mobile, deals and commerce while putting consumers back in control and enables users to get quick feedback from the friends they trust.

For example, a user can request a Nod/Nah from other users during the product shopping through shopping cart to get real-time feedback from friends on purchases. At the point of shopping, the user can also ask for a Nod/Nah from a specific product page online (any website) so that their friends can respond instantly/quickly (takes the Offline concept of how the product conversation works and integrates it to the online retail experience).

Ask for Nod: Product Feedback (“What do You Think about this?)

As disclosed herein, one aspect of the disclosed embodiment allows a user to solicit feedback from other users on a product/service of interest to that particular user. When a user identifies a product/service of interest, the user can use his mobile device having the product conversation application to identify the product/service of interest. For example, the user can use his mobile device to capture an image (e.g. take a picture) where the system can identify the image through image recognition capabilities or barcode identifying the product/service, search for a product/service using text or voice recognition, describe a product/service using voice recognition or other means, or use NFC (near field communication) to identify a product. An NFC reader can be associated with a specific user to identify products of interest to that user, and that data is preferably not shared outside of the user's closed system. Such a NFC reader would read the product information and simply store it for the user's later use (e.g. the user could launch the application to get feedback or simply save to wish list), but data linking the user to the specific product would preferably not be shared.

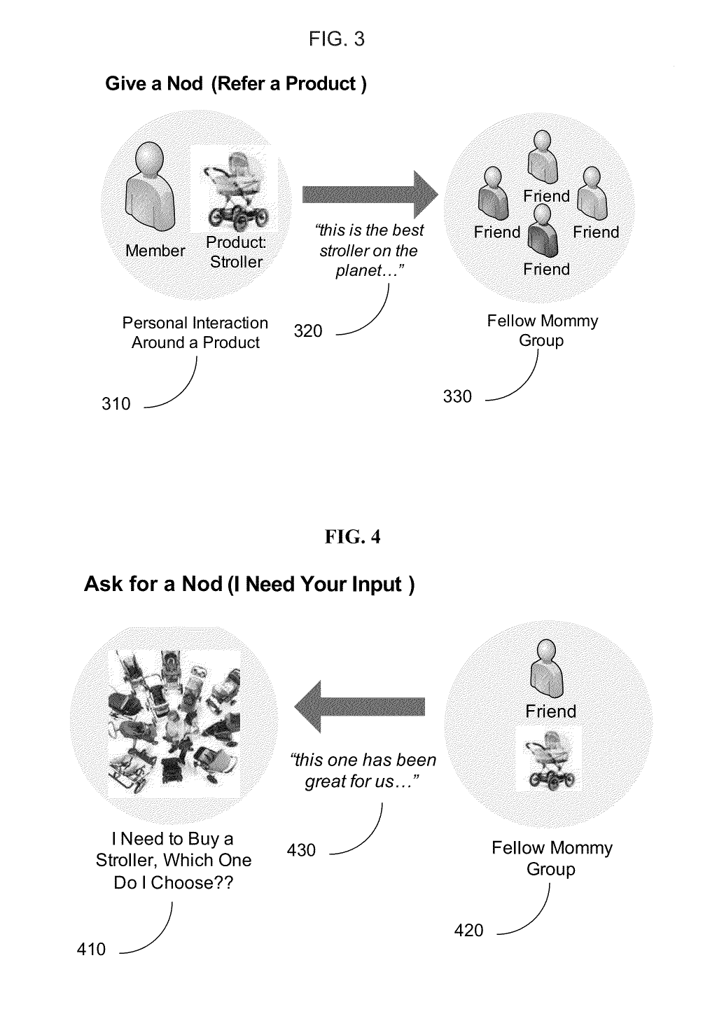

When the product/service is identified, the user will preferably have information about the product/service such as the name of the product, pricing information, and reviews of the product/service. The user can then send a request to one or more other users regarding the identified product for feedback. Those users can then provide feedback regarding the product/service by any means, for example, SMS, and can also share or refer other users or friends to the product/service. The user can also craft a referral to friends using the product conversation application. For example, as shown in FIG. 3, a user 310 can provide a referral 320 of “this is the best stroller on the planet . . . ” to a group of users 330. The referrals can also include an additional product rating, such as “Must Have”, “Serious Look”, “Check it Out”, etc., and can also create a personalized referral message.

Ask for Nod: Product Recommendation

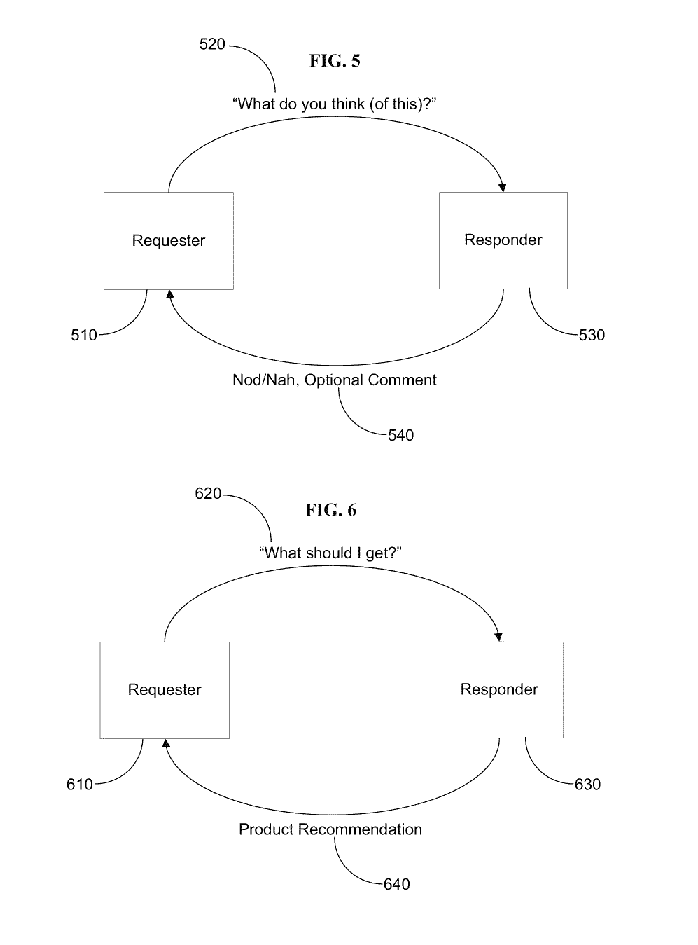

In addition to asking for feedback on a particular product/service, the disclosed embodiment also allows user to ask other users for recommendations for products/services. For example, as shown in FIG. 4, if a user is looking for a particular type of product 410 (e.g. a stroller), he or she can enter a description of the product desired, and send a request to other users as described below. Users 420 can then provide feedback or input 430 regarding the request.

Groups/Pods

Groups, which can also be referred to as “pods,” can be created by a user at any time, for example, before or after conversation are initiated. Groups can be created using three distinct dimensions: name, cohesion point, and contact channel. The name aspect of group formation is similar to traditional groups or distribution lists, which specify a list of user names or nickname. Cohesions points and contact channels are described below.

Cohesion Points

Cohesion points specify a central purpose or theme for why a particular group of users should be grouped in the first place, for example, “Close Family,” “College Buddies,” “Sailing Group,” “Executive Management,” and the like. Groups of user can thus be linked by a point of cohesion.

Contact Channels

In existing groups formed in Facebook™, Google+™ (Circles), Twitter™, email distribution lists, group texting lists (GroupMe™), and the like, groups of people are locked into a contact channel based on the inherent application within which the group was created. For example, an email distribution list is simple a list of email addresses, a group texting group (GroupMe™ for example) is a collection of people's mobile phone numbers, etc.

In contrast, according to the disclosed embodiment, the product conversation platform works across all channels to enable a user to associate users with a mix of contact channels, such as SMS, email, social network contacts (Google™ Circles), Twitter™ direct message contacts, or any combination thereof. The group cohesion point is the same, but the contact channel may be different for the various members within a group.

Thus, when adding a new user (e.g. friends) to the system, for example, to a group or when preparing a request, a user can enter contact information for the new user including indentifying information (e.g. user name or nickname) and information relating to how the user should be contacted (e.g. email, SMS, MMS, social network, proprietary communication network including a browser or mobile app, etc.). The information relating to how the user should be contacted should include both a communication channel (e.g. email, SMS, MMS, social network, proprietary network, etc.) and optionally a communication-channel specific address (a phone number, email address, social network ID, proprietary network ID, etc.). Alternatively, in one or more embodiments, a communication-channel specific address is not required for each user, such as when the communication channel is a social media network. In this manner, when a user is selected to be the recipient for a request or other communication, the system has the information needed to contact that user. In existing systems, distribution lists are simply lists of people and the method of contacting (the how) is assumed based on the system being used. For example, if an email distribution list is being used, then the list comprises email addresses, if it's a Google+™ Circle, then it's a group of people on the Google™ social networking platform, etc. According to the disclosed embodiment, the user information include both the “who” and “how” aspects, and users with different methods of contact (email, SMS, social network, etc.) can be combined in a single group. The group, or Pod, specifies both the list of users and how those users should be contacted.

A master contact list may also be utilized to allow users to access and select users from any contact or friend lists that exist in separate applications or networks. For example, users can be imported from social networking sites, mobile device contact lists, enterprise contact lists, etc. By accessing the individual contacts across the networks/sources, a user can create a group that spans across multiple contact channels. Furthermore, there is no requirement that the user have access to each of those channels separately to communication with other users, as communications are preferably through the product conversation application.

Thus, referring again to FIG. 4, after describing the type of product/service that is desired, the user selects friends or other users 420 as recipients of his or her request for feedback. The user may post his or her request to a social network, such as Facebook™, Twitter™, Google+™, etc., to obtain feedback, and may also use SMS, email, and the like, and the product conversation application can integrate the contact sources of the audience, such as previously created groups in the application, contacts from Facebook™, Twitter™, LinkedIn, etc. The path of communication or preference/affiliation isn't critical, as the system facilitates and integrates the user-requested direct feedback no matter the network.

Users may also create groups of other users after a product/service is identified. For example, if a user commonly sends requests to the same group of users (e.g., “hey, I always find myself asking for golf advice from the same 4 people . . . I will save them this time as a “Pod” so I don't have to manually add them in the future”), that user can save them to a group. Furthermore, groups can be saved for later use, and the user can create a unique custom name for the selected group of audience to which the conversation is being sent. For example, the user can create a group after an event has occurred (rather than having to pre-define a group anticipating the future need for that specific group). In another scenario, the user can craft a specific request and seek advice from a selected group or audience on any topic/product by entering the description of request and create a request. Or in another scenario, the user can get updated access to another person's pod that allows a formal group to manage product conversations.

Also, when sending requests or providing feedback as described below, users can pre-populate messages for quick touch messaging, including, for example, user-defined messages from a pre-populated list of messages, pre-defined messages appear in the flow allowing someone to simple touch the message to send out, rather than type the same, “should I get this . . . ” message like they'd have to do in an SMS or email message, and the like.

Give a Nod: Feedback or Recommendations to Requests

When a user receives a request or other information from a requesting user (e.g. the requester), the user receiving the request (e.g. the responder) has a variety of options. If the requester has identified a specific product/service, the responder can offer a simple positive or negative response and provide comments, if needed. As described herein, if a user agrees with the person's question or comment about the product, they can respond with a “Nod.” If a user doesn't agree, they can respond with a “Nah.” In the alternative, if the requester is instead seeking a product recommendation, the responder can provide the requester with a product recommendation by name, link, etc., and also provide the requester with additional comments, if desired, for example, in FIG. 4, feedback 430.

More specifically, once the product/service information is received by the recipients, they can immediately give feedback to a user by either using their mobile device having the product conversation application, by using the mobile website from their mobile device's browser, or by using the product conversation website on their computer. The feedback from the users can be a simple “Nod” or a “Nah”, and the number of “Nod” or “Nah” from various users can be counted, and aggregated scores for that product is created, based on feedback from friends that can be displayed on the mobile device with the product conversation application.

The responder can also control how other users contact him or her. For example, there are centralized management/preferences for messaging around products (e.g. users tell the system if they want to be notified). In addition, each user can inform the system how and how often they want to be contacted (SMS, in app only, email, any combo thereof). Thus, if a user is sent a request to their work email address, for example, but that person has configured the product conversation application to only contact them via App communication, the request would be re-routed by the system to the user's App despite the fact that the friend sent it to the email address. Thus, the system can control communication routing. The system can also manage/control spam and over-use of the system.

Furthermore, the recipients of the request can acknowledge to the topic/product by clicking on a referral link to purchase. The referral contains information that enables the recipient to respond to the referring party, reading reviews and seeing the price and any deals. The recipient can see the summary list of the nods sent to the recipient and also can see if there is any existing deal for the product. The recipient can respond to the referring party by a preformed response like “Have it”, “May be”, “Not for me”, etc. Users can also manage referral requests by reviewing their in-bound requests for nods through a consolidated screen where the application can manage the comments similar to an inbox where users can review comments from their friends. The user can, at his/her discretion, delete the requests, respond to the requests, and update the requests. The user can also be able to prevent any further in-bound/out-bound communication.

The “Nod” and “Nah” voting features can be modified to suit the preferences of each user as described below.

Personalized Faces

According to the disclosed embodiment, a user can personalize the images used when providing feedback. For example, a user can use a custom picture, such as a picture of his or her own “Nod” and “Nah” face, and use that image to replace the default images. Also, a user can use a video, such as a video capturing that user's reactions/gestures reflecting a “Nod” or a “Nah,” and pass the video through to the recipient instead of the static graphic nod/nah faces. These images and videos can be obtained through any means, such as captured using a camera or camcorder on the mobile device.

Gesture Motion on the Phone (Gyroscope) Relating to Human Behavior

In addition, users may provide feedback using gesture motions utilized by many mobile devices, and the product conversation application may be configured to interpret any motion or gesture as an input. For example, a user can shake the mobile device in a specific pattern and frequency to mimic a nod (move the phone forward and back motion) or a nah (side to side motion or a twisting motion), and the system would recognize the motion and provide the associated feedback. The user may also customize the motions associated with “Nod” or “Nah” to suit his or her preferences. Complex motions or gestures, sequences of motions or gestures, variations of motions or gestures, and the like can also be interpreted by the product conversation application as inputs. Exemplary motions or gestures include, for example, directional gestures (front/back, up/down, side-to-side, and the like), twisting, shaking, etc. and any combinations thereof.

Furthermore, the mobile device may be configured to allow certain motions to be associated with the product conversation application regardless of whether the application is currently being used. For example, if a user is surfing on the web or looking at an existing picture on his or her mobile device, the user could use the associated motion to cause the application to launch. The application could also be configured to initiate the feedback process in response to the motion.

As an example, suppose a user is shopping on her phone on an eCommerce site, looking at a new purse. She gestures using the above “Nod” motion to indicate to her phone that she “likes” this item. The phone responds by popping up a box that says, for example, “would you like to “Nod” this out to a friend?” If the user indicates that she wants to provide feedback or a referral to the item, the product conversation application takes over and the user go through the normal referral/feedback flow as described herein. This scenario could be duplicated with a photo that the user has on their phone of a product, after a user has scanned something with a barcode scanner outside of the product conversation application, or after a user has identified a product using NFC.

Facial Gesture Recognition of the Actual Human Reaction/Feedback (Camera-Based)

Similar to gesture recognition, the mobile device may be equipped with a camera capable of capturing a user's facial movements. In this regard, the camera may be configured to recognize an actual motion human gesture, such as the user shaking his or her head, nod or nah, and translates that motion into a program command (e.g., registers your “Nod” vote by capturing the user actually nodding their your head). The system would then register this as the user's feedback/input or kick-off the referral flow as described in the above example.

It is preferred that only users privy to a specific conversation will be able to view the user-specific feedback. If users not privy to the conversation wish to view feedback for a particular product/service, the feedback may be presented in anonymous fashion. The product conversation system can search a product databases (Google™, for example) and can provide the contents of the product/service, such as where the product can be purchased, its price, or the like, both offline and online. Based on the information provided, the recipients can purchase the product using, for example, the product conversation application or a web application.

Quick Advice Buttons

Similar to the Facebook™ “Like” button that can be placed on webpages, browser extensions or other tools can be used to integrate product-page specific buttons associated with the product conversation application. Users can hit their Nod/Nah feedback, or simply launch a mini-window enabling them to ask for advice from their pods (when logged in) directly to their Pod friends.

To supplement the above-described exemplary scenarios, the following exemplary interactions between a Requester and one or more Responders are also enabled by the disclosed embodiment using the product conversation application, and illustrated in FIGS. 5-9.

FIG. 5: Ask for a Nod: What do you think (of this)? Need Scenario: A user/requester 510 is soliciting feedback on a specific identified product. The user sends a request 520 (e.g., “I am thinking about buying this sleeping bag, what do you think . . . should I get it?”) to responder(s) 530. Response Scenario: Friend responds 540 with a Nod/Nah and (optional) a message, which is either a pre-defined quick response or a custom typed message.

FIG. 6: Ask for a Nod: What should I get? Need Scenario: A user/requester 610 needs a product within a category, but is unsure what to get, and needs friend input for recommendations. The user sends a request 620 (e.g., “I am thinking about buying a sleeping bag, what kind do you think I should get?”) to responder(s) 630. The Response Scenario: Friend responds 640 by either inputting simple text (you should buy the North Face arctic cat super light model X11), or by identifying a product (picture, search, barcode scan, NFC) and sending through a specific product recommendation.

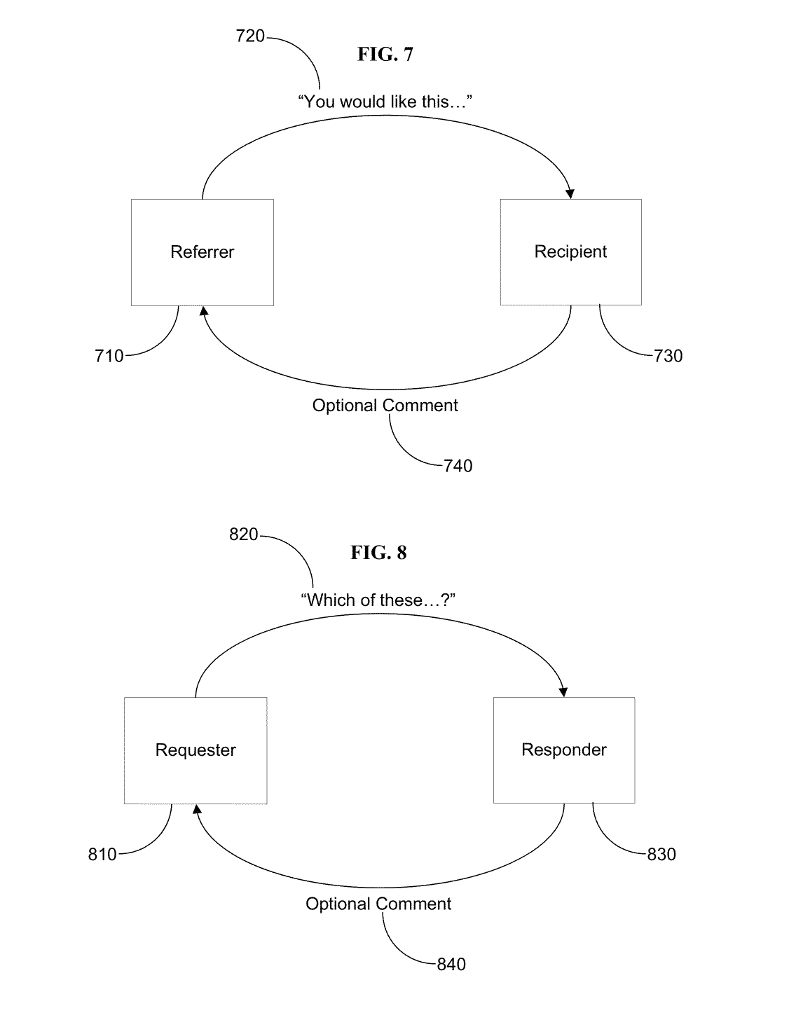

FIG. 7: Give a Nod: You would like this? Need Scenario: A user/referrer 710 sees a product and sends it and a message to a friend that they would like it, not like it, or be otherwise interested in it in some way. Referrals can be in response to a request for information (“What should I get?”) or unsolicited (“I just saw this and it reminds me of that conversation we had two months ago . . . ”). Response Scenario: While no response is needed, the recipient 730 could respond 740 via the “what happened” functionality (“I bought it”, “Not for me” etc). [0080] FIG. 8: Ask for a Nod: Which One? Need Scenario: A user/requester 810 send a request 820 to responder(s) 830 regarding a comparison between a few specific items. Response

Wish Lists

In addition to requesting feedback and product recommendations, the disclosed embodiment further enables users to use wish lists, which are listings of products/services that are of interest to the user. Users can modify which products/services and/or categories of products/services are included in their wish lists. When product pages are viewed by a user either through identifying product or request for feedback, users can select that product to add it to a wish list. User can share their wish lists with other users, and can also view lists for other users. Wish lists can be used as gift registries, for example, and users can indicate whether they have purchased an item off of another user's wish list.

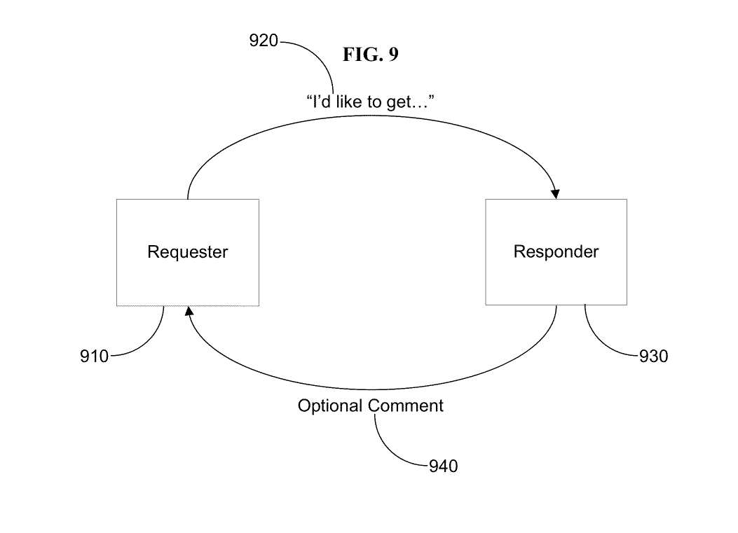

FIG. 9: My Nods: I′d like to get . . . Need Scenario: A user/requester 910 can use the product conversation application as a wish list builder (e.g., a collection of products the user wants to get for himself) and send a request 920 to responder(s) 930. For example, a user could send a specific list created to a specific group of people (e.g., “Birthday ideas”). Response Scenario: None needed, although responder 930 could respond 940 that he or she purchased an item from the list, for example, if the list was a gift registry or the like.

Trusted Sources

The product conversation application also preferably classifies users as being trusted sources or standard. If a user is a trusted source, they are given more access to the system. Exemplary trusted sources are bloggers or other people with “clout” which users can include in their “pods” to request feedback from (e.g., a mommy blogger expert that gives product recommendations). A standard users may also be nominated or identified to be a trusted source from analysis of the user history. Trusted Source users are preferably given the ability to post recommendations to allow for standard users to find and access these recommendations, share in affiliate revenue from recommendations, and integrate Nods into social media platforms.

While some of this functionality may be available to standard users under certain circumstance as well. The product conversation system preferably integrates recommendations/referrals from trusted users on the system, and enable normal users the ability to add them to their pod lists. This will help users by giving them access in the application to “expert” sources and will facilitate more robust relationships for trusted source bloggers through an easy feedback mechanism (“Nod” or “Nah”).

Public Figure

In one or more embodiments, the systems and methods disclosed herein are integrated into a streamlined product placement service involving a public figure, including but not limited to celebrities, politicians, entrepreneurs, spokespersons working on behalf of business entities (including non-profit organizations), entrepreneurs, and any other public figure.

For example, a public figure or a representative thereof may select a product, which may be performed using a product identification user interface. A request may be sent to a selected group comprising at least one member. For example, the group may include one or more members who have requested association with the public figure (e.g. individuals who have “liked” the public figure on one or more social media networks, provided their e-mail address to a fan base organization for the public figure, or otherwise associated themselves with the public figure). The group may include members who are reached via one or more different communication channels.

The public figure's request regarding the product initiates a product discussion based on the public figure's request. An advertiser may enter an advertisement agreement with the public figure and/or an application developer providing the application. The advertisement agreement includes at least one targeted deal related to the product. For example, the targeted deal may be a deal for the exact product, different products by the same brand and/or company, products by a competitor, or the like. In one or more embodiments, the public figure's request involves a generic product category, and the targeted deal is for a specific product in the generic product category.

In one or more embodiments, the targeted deal is offered to one or more members of the group. For example, the targeted deal may be sent to one or more participants who have responded to the public figure's request. The targeted deal may be further tailored based on the participant's answer to the public figure's request.

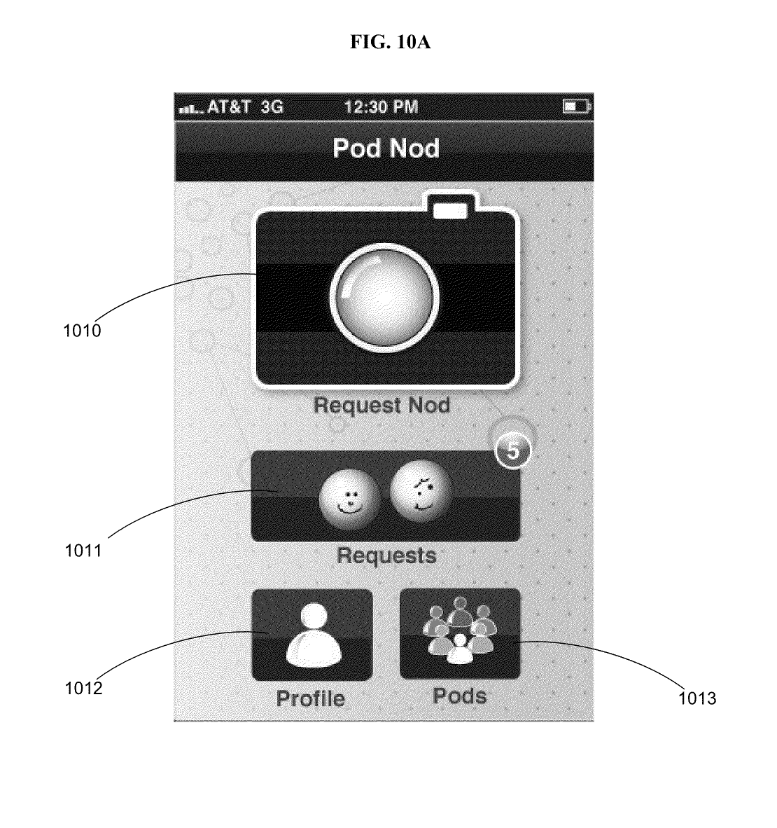

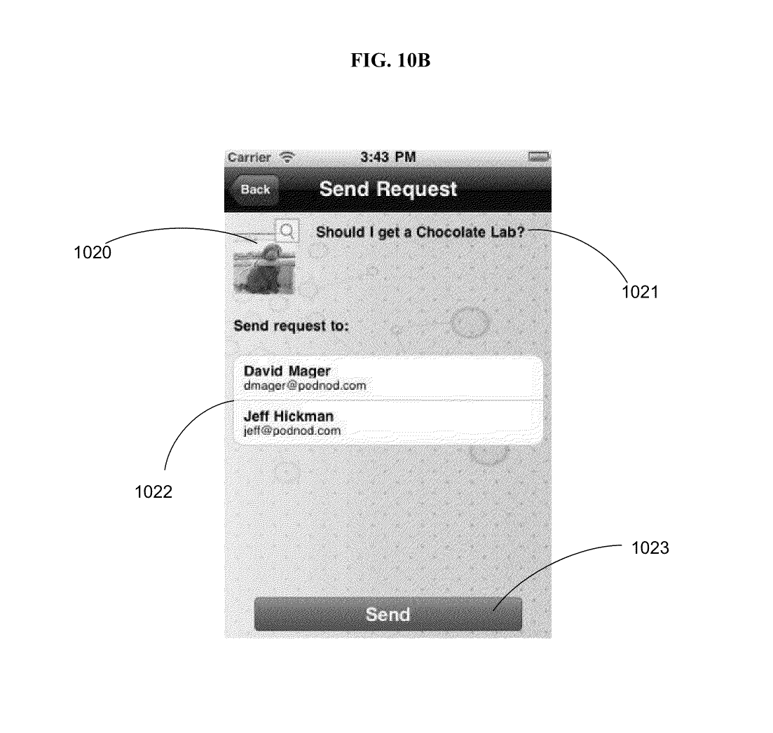

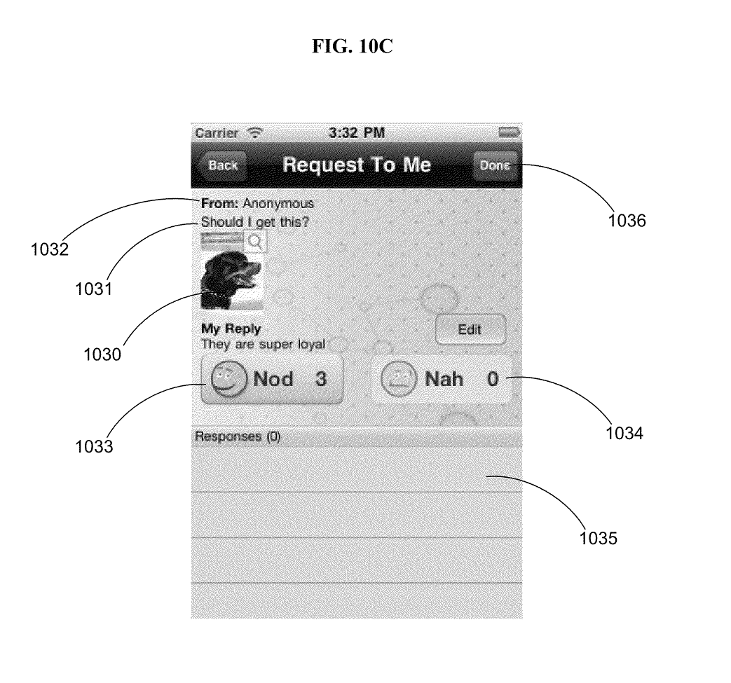

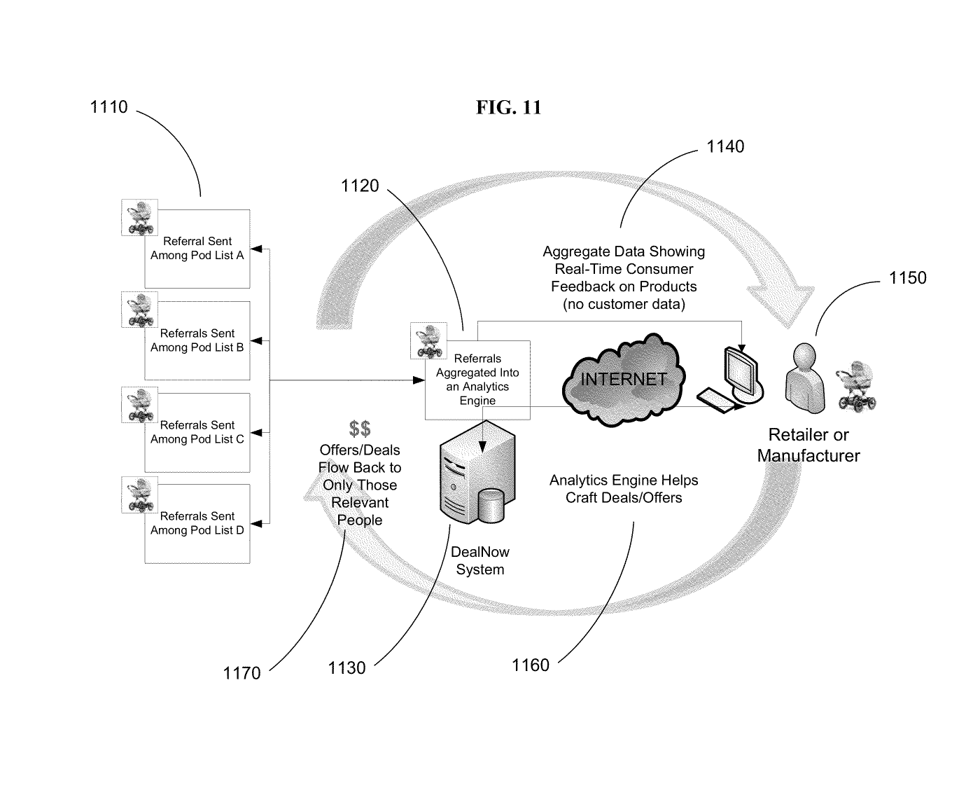

FIGS. 10A-10C illustrate exemplary user interfaces for the conversation application on a mobile device, which may include many different options and preferences.

For example, the user interface preferably includes an option for requesting feedback for a product where a user can select a product/service and send a request to selected contacts by capturing the product data. Multiple paths can be used to capture the product data. The multiple paths for capturing the product data can include options like Snap, Speak, Search and Swipe. By using the Snap option, the user can take a picture of the product or a Barcode (OCR recognition, Google™ search). By using the Speak option, the user can record product description to be searched/found (via Google™ search). By using the Search option the user can initiate a web search via browser and by using the Swipe option, the user can swipe to capture product/service information utilizing NFC technology.

In addition, the user interface preferably includes an option for providing feedback to requests, for example, by viewing inbound requests for recommendations or referrals (e.g. “nods requests”) via a consolidated screen. The user can select a referral request and read those details.

The user interface also preferably includes profile options for managing the preferences of the user and manages the account of the user. Thus, the user can have a high degree of control over personal information stored in the product conversation system. The user can associate with more than one email address per account and has the option of blocking the list. The user can select and manage multiple sources for product review and rating content, can also manage the predefined responses within the system and can configure the visual imagery or pictures used for the “Nod” or “Nah” faces.

The user interface preferably further includes options for managing Pods, or groups of users/friends. The user can delete, modify the existing list and can also add new contacts to an existing list across all platforms or social networking sites, for example, Facebook™, Twitter™, LinkedIn, and the like.

The user interface may also include an option for viewing “Hot Nods,” which is a listing of popular, trending topics, for example, popular products, users, etc. These items are preferably unrelated to the specific user, but are instead based on trends within the entire system, across all users. For example, “Hot Nods” can be used to inform users of new products that have been getting a lot of interest within the community, regardless of whether the user has any connection to that product.

FIG. 10A shows an exemplary home page for the application. In FIG. 10A, the user interface includes options for requesting feedback on a product/service 1010 (“Request Nod”), responding to requests 1021 (“Requests”), accessing a user profile 1012 (“Profile”), and accessing user pods 1013, which are other users selected by the user (“Pods”).

FIG. 10B shows an exemplary “Ask for a Nod” interface. In FIG. 10B, the user may select/identify the product/service using image 1020, ask a question 1021 (or include a comment) regarding the request, specify users 1022, and send the request via button 1023.

FIG. 10C shows an exemplary “Give a Nod” interface. In FIG. 10C, the request page includes product identification image 1030, the request question or comment 1031, and “From” field 1032. Button 1033 may be used to “Give a Nod” and button 1034 may be used to “Give a Nah.” Comment field 1035 can be used to review comments made by other users.

Desktop Configuration

In addition to implementing the product conversation application on a mobile device as described herein, the systems and method of the disclosed embodiment may utilized on any type of computing device, for example, on a desktop computer. In this scenario, the application can be configured as a browser extension or a computer-based “App.” Users can install a browser app that links to their account. The program can run in the background, similar to other apps on a Mac (or in browser as a browser extension). When using this configuration, a user can, based on the page/screen open, get feedback, give recommendations, add to a wish list, etc. In addition, similar to the mobile device application, the browser application will have a push notification capability so that users are alerted when new requests arrive in their account. A notification counter can be displayed, for example, in the browser app icon. It is preferred that the desktop application be integrated/synced with the phone application so that as a user responds, no matter the device, the system is updated and synced across all platforms Any notifications could be real-time feedback, assuming two users are signed in at the same time.

Deal Network

The disclosed embodiment further relates to the use of a deal engine that is capable of providing targeted coupons and advertisements to users based on information collected about their usage of the disclosed systems and methods. The deal purchase process has four general steps, including searching for a product to get feedback on, summarizing feedback on the product, receiving deals associated with that product, and purchasing the product. The deal engine includes the following generalized functionalities.

Data Structure of the Deal Engine

Each product is preferably identified in the system's database through UPC ID technology that analyzes the UPC code and groups items to take into account variances in UPC coding but not in the actual product. This is accomplished with a combination of image comparison, product description, and product naming, allowing for a more accurate tracking of activity related to products.

When a product is first exposed to a user and the user responds to being asked for feedback, given as a recommendation, adds it to a wish list, or responds to a comparison, that interaction becomes a parent and every subsequent time that user relates that product to another individual. In some cases, the geographic flow and adoption of product trends, purchases, and consumer sentiment can be tracked. Being able to track those influencers over times allows the system to create a Product Awareness Graph to identify influencers of product conversations including purchase.

Each interaction including receiving, opening, not-opening, Nod/Nah response, type of response, content of response, what happened status can also be collected for use in the deal engine.

Analytics

The deal engine provides product specific tracking of influencers (data architecture tracking migratory effect of friends of friend sharing of nods), as well as relative discussion traffic.

Product Interest Identification (PII): Needed to identify not which types products a user might be interested per a Social Graph and any external analysis of behavior, but to identify which specific product or detailed product category the user might be engaged in a conversation at the point of the conversation (they have already implicitly indicated interested). This enables highly targeted deals, coupons, and decision information to be presented at the point of trusted conversation. In essence, the offer exists within the trusted conversations thereby the offer gains the trust through transference.

Products can be identified directly or indirectly. Direct identification includes, for example, a product search or a bar code scan. Indirect identification includes image recognition software of packaging or product, a text analysis of product conversations including requests for recommendations, comments, and what happened, the degree of interactivity around product Thus, the system has the ability to embed a product-specific (or category/brand) deal or offer to a user, after that consumer has started a “conversation” with others about that product. For example, the system knows, down to the specific product model number, what product is being discussed in a Nod request communication. The system can, after the conversation has occurred, scour the publicly available deals/offers or private/custom negotiated deals to serve up a compelling offer to the consumer as they have that dialogue among friends.

Product Awareness Graph (PAG): The tracking of influence of exposure to products and the effect of that exposure to nods/nahs, recommendations, conversation activity, and purchases of the product. Each product, product family, brand, and category will have Product Awareness Graphs associated with them. Conversation components contributing to the product's Product Awareness Graph include intensity (recent activity), longevity (activity over time), exposure (number of people interacting), influence (the distance the product conversations travel from a person), action (purchase or purchase indication), sentiment (real-time consumer opinion of products), and the like.

Products can also be given an aggregate score based on feedback received. For example, counting the “Nods” and “Nahs” a product receives during product conversations lead to the creation of the aggregate score for that product, which is quantifiable data.

Data Security/Privacy: The PAG will be aggregated data that is not related to any specific person. The PII related to participants within the Pod where the conversation is occurring will be identified and protected through user number and kept from any particular advertiser or deal offerer. The idea is to gather and analyze aggregate data, to offer the opportunity for marketers to reach people on the product conversation network, but not to sell out the users. The focus becomes product-centric knowledge and data.

The data that should be available for initial collection during use of the disclosed embodiment includes, for example, geographic location of identified product, location of referrals (friends receiving), local deals in the nearby vicinity, time of day item identified, exact product (brand, product/model), product category, opinions/ratings of product and related trends over time, friends rating of product, trends between “local” groups and “social” groups (those that use Twitter™/Facebook™ vs. tight/closed groups), method of communication (email, app, email, social), shoppers vs. buyers, adoption of mobile purchasing, phone type, influence of word of mouth marketing vs traditional advertising, cross correlation between influencer data and the product lifecycle (understanding how the role of the influencer works in new product launch and adoption cycles), simple views/clicks data on products, deal/offering influence factors (what motivates people to purchase, how much of a discount, in what form (coupon/rebate/etc), influence factors by product type/category, correlation between offering amount and strength of pre-determined product opinion based on friend feedback), and the like.

Additional data should become available as the system becomes more integrated with websites, browsers extensions, online buttons (think of the “like” button on product shopping pages) & NFC/eWallet™s, the complete picture of shopping, the integration of offline and online behavior and data, includes, for example, an improved view of product awareness/trends between offline shopping and online shopping, shopping behavior (search online, solicit opinions on-line vs. through app, usage of the product conversation application instore vs. on web, purchase location, purchase method), transaction values and volume, location purchase vs. shop, computer and Smartphone hardware profiles for users, and the like.

The above information can also be used to track and aggregate, no matter the end destination, who and what information a user has sent and the conversation around that product no matter the source (web, app, other). For example, suppose a user requests help from three friends for input to a product: Jane, Bill and Nancy. The user uses Jane's mobile number, Bill's email address, and Nancy's direct connect in Twitter™. The friends send back feedback (either in the App or on the product conversation website). The product conversation system is the central repository for that conversation, so the user doesn't need to go to his or her SMS messages, email and Twitter™ accounts to see the feedback thread. Instead, it's all located in one spot, the product conversation system.

By collecting and aggregating the above data, the system can also present analytical information to a marketer/manufacture about their product. The system can thus anonymously aggregate product level discussions and data, based on the nod/nah indication, for all products flowing through the system, and use analytics and custom mining tools to build a “consensus” profile of feedback of that particular product, and display that to the manufacturer and/or retailer. This type of analysis can be done at a product level, or brand level. The retailer/manufacturer can then act upon this data.

FIG. 11 illustrates an exemplary flow for providing retailer feedback. In FIG. 11, users 1110 provide referrals or other feedback on products. The referrals are aggregated into an analytics engine 1120 in a computer system/server 1130. The system 1120 compiles aggregate data 1140 including the consumer feedback, preferably without customer data, and provides the data to the retailer 1150. The retailer can then provide raw offers 1160, which can be crafted, with the assistance of the analytics engine, into offers/deals 1170 for relevant users.

Retailer/Merchant Deal Creation

The deal engine creates deals with retailers and merchants to provide users with the best possible deals. In addition, the deal engine creates deals based on a variety of factors including, for example, category/brand/product, the percent discount desired, geography, and redemption.

Deal Presentment

The deal engine can present deals in a variety of ways. For example, deals can be identified and presented based on an identification of discussions regarding a certain product or service. As described herein, products and service can be identified and presented in a variety of ways, for example, through product ID, image recognition, discussion keywords, and the like. In addition, deals can be ranked based on a variety of factors, such as response rates, close rates, the value of each deal, and the like.

Deal Fulfillment

One aspect of offering deals is deal fulfillment. Deals can be fulfilled in any manner, for example, providing prepaid coupons to users, shipping vouchers or products to a user, and the like.

Thus, the deal engine performs as an intermediary between consumers and marketers by protecting the interest of both the consumers and marketers. The deal system acts as a buffer between retailer/manufacturer trying to drive product volume, and those who are having product conversations. Its primary function is to match the right offer and the right product to the right conversation and person within the conversation. The deal engine is a sophisticated self-service system that enables marketers to test offers, refine campaigns and drive purchases.

The deal engine system can analyze the discussion list to provide retailer/manufacturer an aggregated real-time anonymous view of the level of “Nod” activity of various products/service across all users. Based on the activity, the manufacturers of the products can then make deals based on predefined recommended structures to ensure enticing offers flow back through the deal system, to incent/drive purchase. Based on the site purchase behaviors of various offers, the deal system comes to know as to which product will click and which product might not work thus helping the retailer/manufacturer to manufacture a certain product that can click. The deal system then analyzes the Expected Deal Effectiveness (EDE) using custom algorithms based on multiple variables like monetary value of the deal, proximity to user, previous deal purchases, deal click rate, deal close rate, and retailer/manufacturer deal success history. The offers are then passed only to relevant users. The retailer/manufacturer can refine and amend offers in real-time based on sales performance. [00124] By using the deal system, the application facilities a “pre-buy” of a deal offline by using integrated “coupons”. The application manages the cash float and the retailer's process transaction. NFC has the potential to automate the entire process starting from referral to reward.

The application also enables integration with an online payment firm, such as Amazon™, PayPal, etc. The online payment firm accepts the NFC/mobile stored wallet as credentials for payment. The payment using NFC “eWallet™” offline is done when the “coupon” is “pre-loaded” into the phone's “eWallet™”. The “eWallet™” option is selected by the user and the user's mobile number is entered. The request for payment is then routed to the user's phone and the “eWallet™” application is then launched, prompting the user to verify a pending purchase by typing a 4-digit pin number. The authentication is sent back through to the online payment firm and transaction is processed. After the payment is done, the manufacturer may ship the product.

eCommerce

In addition, the disclosed embodiment further provides and supports eCommerce applications. For example, users can use the disclosed systems and methods to purchase products/services, obtain and utilize coupons, view advertisements, and the like.

More specifically, users can purchase products/services using their mobile devices. For example, if a user identifies a product and is interested in it, he or she can order/purchase the product directly. Thus, the disclosed embodiment has retailer/merchant integration. Furthermore, user information, such as shipping information, payment information, and the like, can be stored within the system for ease of use, or can be entered by the user at the time of purchase. In addition, any known means for payment can be used, such as eWallet™, PayPal, etc. NFC technologies may be used to facilitate purchasing and payment.

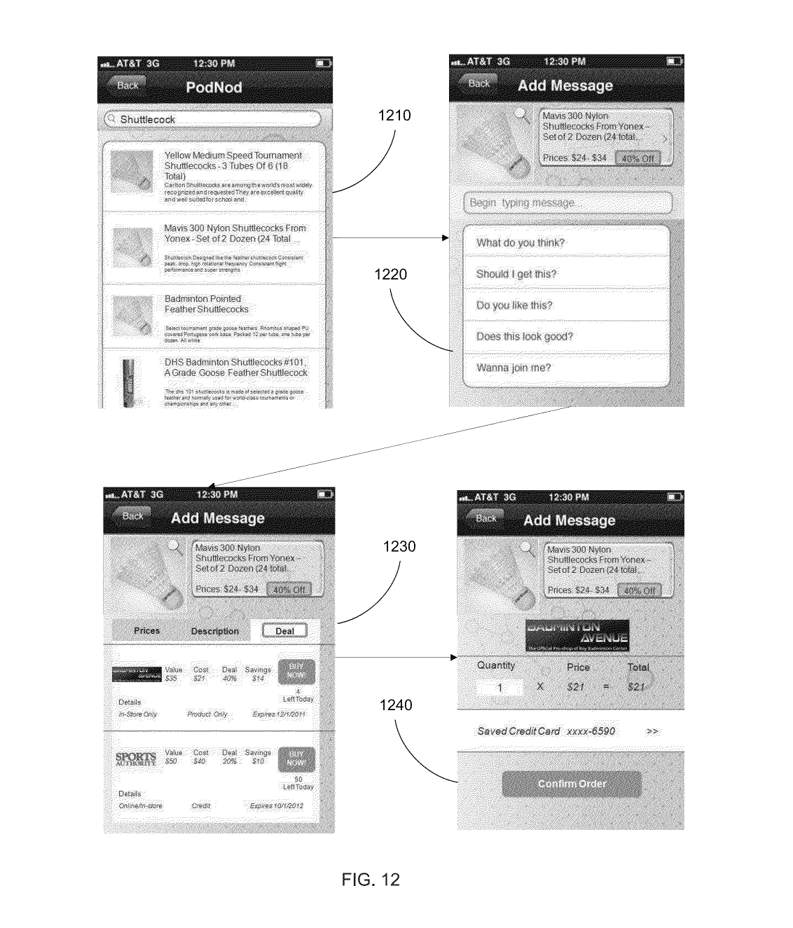

FIG. 12 illustrates an exemplary user interface experience for a purchase using the disclosed embodiment. Interface 1210 shows a product select screen where a user can select a product of interest. Interface 1220 shows a request page where a user can ask for feedback. Interface 1230 shows a product page reflecting available deals/offers for the identified product. Interface 1240 shows a purchase page resulting from the selection of one of the offers.

Coupons and/or advertisements can also be targeted to users based on products/services that are of interest to them. For example, relevant coupons/advertisements can be identified based on product known to be of interest to a user, such as products for which the user has requested feedback, products which have been recommended by a responder, product that have been provided by a requester, etc.

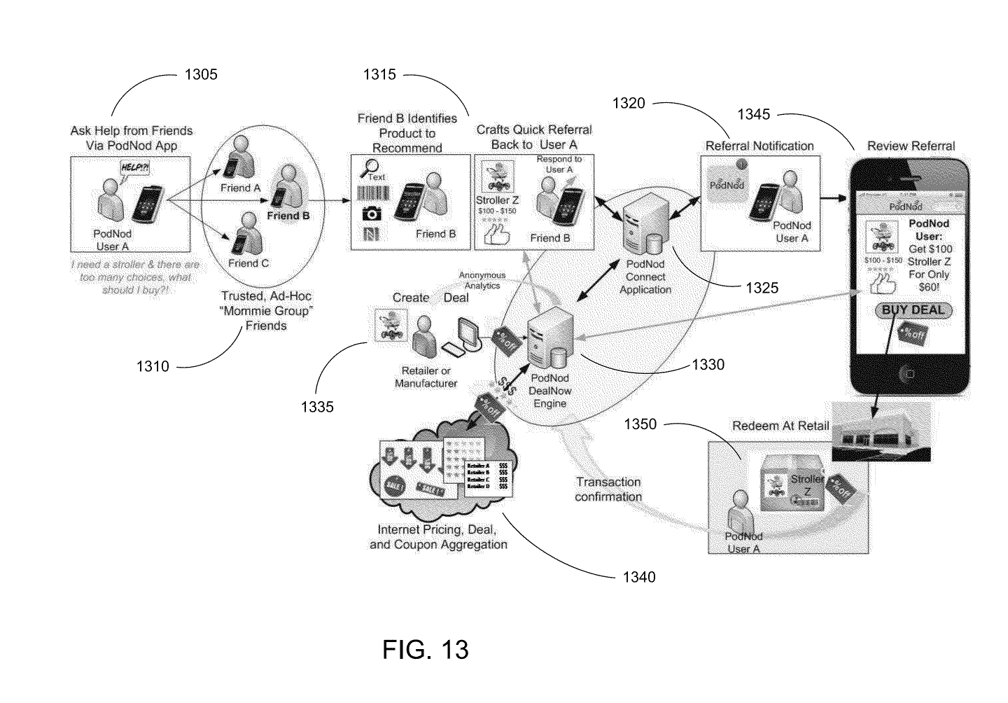

For example, FIG. 13 illustrates an exemplary eCommerce flow according to the disclosed embodiment. In FIG. 13, a requesting user 1305 can identify a product to responding users 1310. Responding users 1310 provide feedback 1315 which goes to the server 1325 en route back to user 1305. The deal engine 1330 communicates with retailers 1335 and/or internet resources 1340 to develop a deal or offer associated with the identified product. The resulting recommendation and offer is presented to user 1305 as a referral notification 1320 on the user's device 1345. The user can then use/redeem the offer at a retailer 1350 to purchase the product.

Social Networking

The disclosed embodiments can also take advantage of social networking platforms, such as Facebook™, Twitter™, etc., and relationship with other users through those networks may be accessed and utilized. For example, requests for feedback, etc., may be sent to individuals, groups, or the general public of these sites.

Product Research

The disclosed embodiment is also useful for researching and identifying products/service that have received feedback from other users. For example, a user can review existing/prior feedback for an identified product and consider that feedback when deciding whether to purchase that product. The user can also identify similar or related products using the application.

Pre-Bates/FUTURECash Concept

Another aspect of the eCommerce application is the ability to offer advance buying arrangements. More specifically, a user can pre-buy retailer specific cash/gift cards (or volume scaling) to receive a future discount. For example, a user could pre-buy $300 worth of merchandise from a retailer a few months before the products are actually needed. The retailer would give the user the purchase voucher at a discounted price, for example, $225. The retailer would have the benefit of the immediate cash and the user would benefit from the discount at the time of purchase.

This scenario is ideal for Christmas shopping, back-to-school shopping, etc., and such a system can stand alone to start and then be integrated into a NFC account deal. For example, as the user goes to retailer to pay, the value of the pre-bought credit is known in the system and applied to the transaction via NFC. The system of the disclosed embodiment would receive a fee for enabling the transaction, and would guarantee the cash flow to the retailer, while the retailer would pay for the discount.

ecommerce Focused (vs. Physical/Location Based . . . Brick and Mortar)

The disclosed embodiment also relates to a system or service that enables e-Wallet type payment integration with an ONLINE/Amazon™ type company, thereby eliminating eliminate the storage of credit cards at the merchant site, preventing hacks/breaches of various data, and a user's credit card information preferably remains locked in an eWallet™ on the mobile device phone no matter offline or online usage. For example, suppose a user is buying something from Amazon™, and selects the “eWallet™” option and enters his or her mobile number. The request for payment is routed to the user's mobile device and launches the eWallet™ application, prompting the user to verify a pending purchase on the mobile device within the application. The authentication is sent back through to Amazon™ and transaction is processed. This is how offline NFC eWallet™s are meant to the work, but the idea here is that it applies online too. A “usb device” that plugs into the computer that acts as a home-users “swipe pad,” Bluetooth integration from phone (or both), or SMS authentication could also be used.

The foregoing descriptions of disclosed embodiment have been presented for purposes of illustration and description. They are not intended to be exhaustive or to limit the disclosed embodiment to the precise forms disclosed, and obviously many modifications and variations are possible in light of the above teaching. The above descriptions and examples were chosen and described in order to best explain the disclosed embodiment and its practical application, to thereby enable others skilled in the art to best utilize the disclosed embodiment with various modifications as suited to the particular use contemplated. It is understood that various omission and substitutions of equivalents are contemplated as circumstance may suggest or render expedient, but such are intended to cover the application or implementation without departing from the spirit or scope of the claims of the disclosed embodiment.

As described above, disclosed is a method and system for sharing information using a product conversation application. The method includes integrating a communication device, deals and e-commerce and can facilitate person to person conversation interactions. The product conversation application provides a personal network application that embeds targeted deals within quick product recommendations and facilitates to allow a marketer/retailer to inject relevant offers to a user based on the product/service conversation amongst a plurality of users.

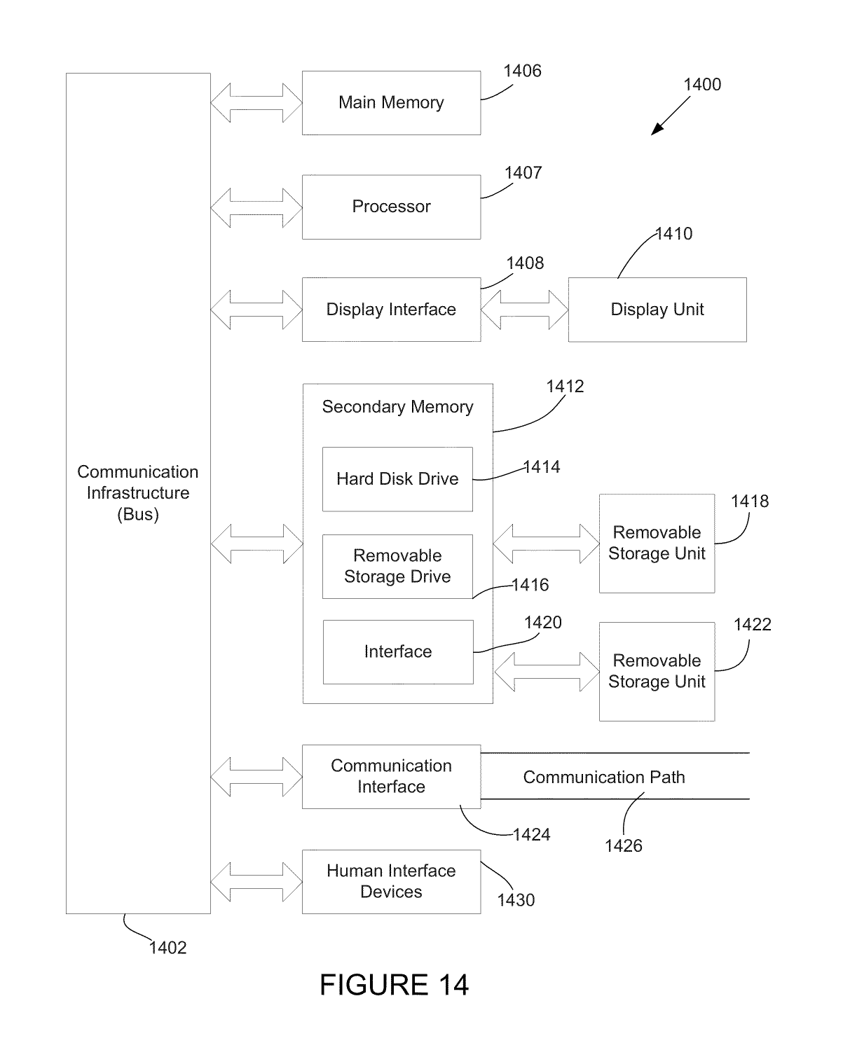

FIG. 14 diagrams a general-purpose computer and peripherals, when programmed as described herein, may operate as a specially programmed computer capable of implementing one or more methods, apparatus and/or systems of the solution described in this disclosure. System 1400 is shown. Processor 1407 may be coupled to bi-directional communication infrastructure 1402 such as communication infrastructure system bus 1402. Communication infrastructure 1402 may generally be a system bus that provides an interface to the other components in the general-purpose computer system such as processor 1407, main memory 1406, display interface 1408, secondary memory 1412 and/or communication interface 1424.

Main memory 1406 may provide a computer readable medium for accessing and executed stored data and applications. Display interface 1408 may communicate with display unit 1410 that may be utilized to display outputs to the user of the specially-programmed computer system. Display unit 1410 may comprise one or more monitors that may visually depict aspects of the computer program to the user. Main memory 1406 and display interface 1408 may be coupled to communication infrastructure 1402, which may serve as the interface point to secondary memory 1412 and communication interface 1424. Secondary memory 1412 may provide additional memory resources beyond main memory 1406, and may generally function as a storage location for computer programs to be executed by processor 1407. Either fixed or removable computer-readable media may serve as Secondary memory 1412. Secondary memory 1412 may comprise, for example, hard disk 1414 and removable storage drive 1416 that may have an associated removable storage unit 1418. There may be multiple sources of secondary memory 1412 and systems implementing the solutions described in this disclosure may be configured as needed to support the data storage requirements of the user and the methods described herein. Secondary memory 1412 may also comprise interface 1420 that serves as an interface point to additional storage such as removable storage unit 1422. Numerous types of data storage devices may serve as repositories for data utilized by the specially programmed computer system. For example, magnetic, optical or magnetic-optical storage systems, or any other available mass storage technology that provides a repository for digital information may be used.

Communication interface 1424 may be coupled to communication infrastructure 1402 and may serve as a conduit for data destined for or received from communication path 1426. A network interface card (NIC) is an example of the type of device that once coupled to communication infrastructure 1402 may provide a mechanism for transporting data to communication path 1426. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 1426 may comprise any type of telecommunication network or interconnection fabric that can transport data to and from communication interface 1424.

To facilitate user interaction with the specially programmed computer system, one or more human interface devices (HID) 1430 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 1407 to trigger one or more responses from the specially programmed computer are within the scope of the system disclosed herein.

While FIG. 14 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 14.

While the invention herein disclosed has been described by means of specific embodiments and applications thereof, numerous modifications and variations could be made thereto by those skilled in the art without departing from the scope of the invention set forth in the claims.

What is claimed is:

1. A system comprising at least one processor and a computer-readable medium comprising computer readable instructions for sharing information, wherein execution of said computer readable instructions by said computer performs steps comprising:
displaying a product identification user interface to a user;
accepting identifying information from said user via said product identification user interface;
sending said identifying information to a server configured to identify a product based on said identifying information;
accepting a request comprising a question about said product from said user;
sending said request to a selected group comprising at least one member;
receiving at least one response from at least one member of said selected group;
displaying said at least response;
receiving at least one targeted deal related to said identified product from said server; and
displaying said at least one targeted deal related to said identified product.

2. The system of claim 1, wherein said product comprises a generic product category.

3. The system of claim 1, wherein said request is sent to said selected group by sending said request to a server configured to send said request to said selected group.

4. The system of claim 1, wherein said product identification user interface is configured to accept identifying information comprising a captured image.

5. The system of claim 4, wherein said captured image is selected from a complete or partial screen shot, an camera capture, a bar code, and a product image.

6. The system of claim 1, wherein said product identification user interface is displayed when said user is participating in a shopping experience to obtain real-time feedback from said selected group regarding a potential purchase.

7. The system of claim 1, wherein said response is selected from at least one of a binary response indicating positive or negative feedback, a custom message, and a preformed message.

8. The system of claim 1, wherein said request is sent via at least one communication channel selected from SMS, MMS, email, a social network, and a proprietary channel.

9. The system of claim 1, wherein said steps further comprise the steps of displaying a communication user interface configured to accept group member data usable to associate a contact with at least one group, at least one communication channel, and optionally at least one communication-channel specific address.

10. The system of claim 9, wherein different members of said selected group are associated with different communication channels, wherein said request is sent to said different members via said different communication channels.

11. The system of claim 1, wherein said steps further comprise:
receiving an incoming request from a second user comprising a question about an second product from said second user; and
sending an incoming request response to said incoming request, wherein said incoming request comprises at least one of a binary response indicating positive or negative feedback, a custom message, and a preformed message from said user about said second product.

12. The system of claim 11, wherein said incoming request response is sent via a communication channel selected from SMS, MMS, email, a social network, and a proprietary channel.

13. The system of claim 11, wherein said steps further comprise:
receiving at least one targeted deal related to said second product from said server; and
displaying said at least one targeted deal related to said second product.

14. The system of claim 1, wherein said user is a public figure.

15. The system of claim 1, wherein said at least one processor and said computer-readable medium are components of a mobile device.

16. The system of claim 1, wherein at least one of said product identification user interface, said at least one response and said at least one targeted deal is displayed in a browser.

17. A system comprising at least one processor and a computer-readable medium comprising computer readable instructions for sharing information, wherein execution of said computer readable instructions by said computer performs steps comprising:
receiving identifying information about a product from a requesting user;
identifying at least one of a product brand and a product category based on said identifying information;
accepting a request comprising a question about said product from said requesting user;
accepting a selected group comprising at least one member from said requesting user;
identifying a communication channel and a communication-channel specific address for said at least one member of said selected group;
sending said request to said at least one member of said selected group via at least one communication channel to at least one identified communication-channel specific address;
determining at least one targeted deal related to said product; and
providing said at least one targeted deal to at least one of said user and said at least one group member.

18. The system of claim 17, wherein said steps further comprise:
receiving at least one response from at least one member of said selected group;
aggregating said at least one response; and
providing said at least one response to said requesting user.

19. The system of claim 17, wherein said steps further comprise:
storing usage information comprising at least one action of at least one user; and
analyzing said usage information to determine at least one tracking metric;
wherein said at least one targeted deal is determine based on said at least one tracking metric.

20. The system of claim 19, wherein said usage information comprises at least one of a geographic location of said product, a geographic location of said requesting user, a geographic location of said at least one member, referrals, local deals in the nearby vicinity, a time of day of request, brand and model information, a product category, trends over time, trends between “local” groups and “social” groups, communication channels, adoption of mobile purchasing by users, phone type, click rates, discount value, and discount type.
